(19) United States
(12) Patent Application Publication
(10) Pub. No.: US 2024/0033975 A1
(43) Pub. Date: Feb. 1, 2024

(54) WASTE TIRE RESOURCEFUL REGENERATION TREATMENT METHOD

(71) Applicant: HEILONGJIANG INSTITUTE OF TECHNOLOGY, Harbin (CN)

(72) Inventor: QIANG WANG, HARBIN (CN)

(21) Appl. No.: 17/894,727

(22) Filed: Aug. 24, 2022

(30) Foreign Application Priority Data
Jul. 29, 2022 (CN) 2022108967243

(51) Int. Cl. B29B 17/04; B29B 17/00

(52) U.S. Cl. CPC B29B 17/0404; B29B 17/0042; B29B 2017/0272

(57) ABSTRACT

A waste tire resourceful regeneration treatment method is provided, including: step S1, sorting, including: sorting waste tires according to types of the waste tires to obtain target waste tires with steel wires; and step S2, bead-cutting, including: performing a bead-cutting process on the target waste tires through a bead-cutting machine, to cut the target waste tires into beads and first remaining portions separated from the beads. With respect to the method, the target waste wires with steel wires are sorted out from waste wires of different types, a bead-cutting machine is used to remove beads with steel wires from the waste tires with steel wires and separate the steel wires from the beads with steel wires, then a series of processes including cleaning, crushing, magnetic separation, fiber separation, sieving, desulphurizing, and cooling are performed to obtain recycled resources of the waste tires.

### TECHNICAL FIELD

The present disclosure relates to the technical field of processing of waste tires, and in particularly to a waste tire resourceful regeneration treatment method.

### DESCRIPTION OF RELATED ART

With the gradual improvement of people's living standards and the rapid development of the logistics industry, a private car ownership and the number of trucks in China increased year by year. The increase in the number of vehicles brings out the development of the economy, while the consumption and wear of tires of the vehicles also lead a lot of garbage, waste tires. Several years ago, used tires are processed as garbage and thrown away, greatly polluting the environment rely on which we live. Waste tires generated each year are increased at a rate of 8% to 10%, an amount of waste tires generated is about 250 million, and a recycling rate thereof is only about 50%, which is less than 50% of the West, thereby resulting in a huge waste of resources. The Waste tires and waste rubbers cause pollution when being piled, so it is better to turn the waste into treasure, and it is further better to generate value benefits. Waste tire processing devices are in a stable development stage of investment, in a relevant reuse field of the rubbers and the waste wires, there are a physical shredding and crushing manner and a manner of crushing and processing of waste tires, and processing devices of environmental protection are mainly used, which adopting technologies such as tire granule line, tire rubber powder device line.

With respect to an existing waste tire resourceful regeneration treatment method, the waste tires are processed by a bead-cutting machine, a trip-cutting machine, a block-cutting machine, and a tire crusher, and the waste tires are finally manufactured into rubber powders after the processing. However, when the waste tires are processed by the crusher, due to the hardness and flexibility of the waste tires cannot reach process requirements for manufacturing ultra-fine rubber powders, resulting in the recycled resources produced from the waste tires cannot be fully utilized.

In view of this, it is necessary to upgrade the related technology based on the above problems, to meet the requirement of the market.

### SUMMARY

The objectives of the present disclosure is to provide waste tire resourceful regeneration treatment method to solve the above-mentioned problems in the background, that with respect to an existing waste tire resourceful regeneration treatment method, the waste tires are processed by a bead-cutting machine, a trip-cutting machine, a tire block-cutting machine, and a tire crusher, and the waste tires are finally manufactured into rubber powders after the processing. However, when the waste tires are processed by the crusher, due to the hardness and flexibility of the waste tires cannot reach process requirements for manufacturing ultra-fine rubber powders, resulting in the recycled resources produced from the waste tires cannot be fully utilized.

To achieve the above objectives, a waste tire resourceful regeneration treatment method is provided in the present disclosure, which may include:
step S1, sorting, including: sorting waste tires according to types of the waste tires to obtain target waste tires with steel wires;
step S2, bead-cutting, including: performing a bead-cutting process on the target waste tires through a bead-cutting machine, to cut the target waste tires into beads and first remaining portions separated from the beads;
step S3, strip-cutting, including: performing a strip-cutting process on the first remaining portions, through a strip-cutting machine, to cut the first remaining portions into strips;
step S4, steel wire separation, including: performing a steel wire separation process on the beads obtained in the step S2 through a tire bead peeler, to obtain the steel wires and second remaining portions separated from the steel wires;
step S5, steel wire collecting, including: centralizedly collecting the steel wires obtained in the step S4;
step S6, block-cutting, including: performing a block-cutting process on the strips obtained in the step S3 and the second remaining portions obtained in the step S4, to obtain tire rubber blocks;
step S7, cleaning, including: repeatedly cleaning the tire rubber blocks to flush dust and impurities attached to surfaces of the tire rubber blocks;
step S8, solid waste and waste water treatment, including: centralizedly processing and discharging solid particle impurities and waste water generated after the cleaning;
step S9, crushing, including: placing the tire rubber blocks after the cleaning in the step S7 into a tire crusher to perform a crushing process on the tire rubber blocks and thereby process the tire rubber blocks into rubber powders, where a precision of the rubber powders is adjustable in the crushing process by controlling a mesh number of a screen of the tire crusher.
step S10, magnetic separation, including: placing the rubber powders obtained after the crushing into a magnetic separator to perform a magnetic separation process on the rubber powders, to remove ferromagnetic materials from the rubber powders through multiple times of magnetic separations;
step S11, fiber separation, including: placing the rubber powders obtained after the magnetic separation into a fiber separation machine, floating fibers of the rubber powders through an airflow produced by the fiber separation machine, and discharging the floated fibers through a conduit under an action of the airflow to obtain the fibers contained by the rubber powders;
step S12, sieving, including: performing a sieving process on the rubber powders obtained after the fiber separation;
step S13, desulphurizing, including: performing a desulphurizing process on the rubber powders obtained after the sieving through a vulcanizer, to heat up the rubber powders and thereby make rubber molecules of the rubber powders cross-linked to change a structure of the rubber powders from a linear structure into a reticulate body structure and obtain a rubber powder product with a certain physical and mechanical property, where in the desulphurizing process, the rubber powders are heated to be softened and water and volatile substances contained in the rubber powders tend to be gasified, a preset pressure is applied through a hydraulic cylinder to make the rubber powders fully fill a mold and suppress generation of gas bubbles and thereby make the rubber powder product have a dense organization structure and reduce pollution of environment due to waste gas;
step S14, cooling, including: performing a cooling process on the rubber powder product obtained after the desulphurizing;
step S15, steel wire gathering, including: gathering and centralizedly storing the steel wires;
step S16, rubber powder collecting, including: collecting and centralizedly storing the rubber powder product; and
step S17, fiber collecting, including: collecting and centralizedly storing the obtained fibers.

In a preferred embodiment, in the step S2, the bead-cutting machine holds and fixes the target wastes wires through a four-jaw clamp of the bead-cutting machine and cuts the beads from the target waste wires in a side cutting manner.

In a preferred embodiment, in the step S3, a cutting specification size of the strip-cutting machine is in a range from 35 millimeters (mm) to 45 mm, and the cutting specification size is adjustable.

In a preferred embodiment, in the step S4, a power of a motor of the tire bead peeler is 15 kilowatts (kW), and the tire bead peeler is electrically connected to an industrial voltage of 380 volts (V).

In a preferred embodiment, in the step S6, a cutting feeding specification size of the tire block-cutting machine is in a range from 35 mm to 40 mm, a feeding-out size of the tire block-cutting machine is in a range from 3 centimeters (cm) to 5 cm, and a cutting tool of the tire block-cutting machine is a carbide tool.

In a preferred embodiment, in the step S7, a pressurized washing manner is used during the cleaning; and in the step S8, the generated waste water is processed by a water processing device to meet a discharge standard.

In a preferred embodiment, in the step S9, the tire crusher is equipped with an air-water-cooled system, a micro dust removal device and an atomization spraying system; and the mesh number of the screen of the tire crusher is thousand meshes and thereby the tire crusher is capable of producing ultra-fine rubber powders.

In a preferred embodiment, in the step S10, the magnetic separator removes 0.1 kilograms (kg) to 40 kg of the ferromagnetic material through once magnetic separation; in the step S11, the fiber separator drives an impeller through a main shaft at an output end of the motor to generate the airflow; and in each of the steps S1, S2, S3, S4, S5, S6, S7, S8, S9, S10 and S11, a gaseous sulfide detector is used to perform a real-time detection.

In a preferred embodiment, the steps S12, S13 and S14 are each implemented in room; and a desulfurization steam temperature in the vulcanizer in the step S13 is controlled to be 540 Celsius degrees (° C.).

In a preferred embodiment, the steps S15, S16 and S17 are all to collect regeneration resources generated from the target waste tires.

Compared with the related art, the present disclosure may have at least following beneficial effects.

With respect to the waste tire resourceful regeneration treatment method of the present disclosure, the target waste wires with steel wires are firstly sorted out from waste wires of different types, then the target waste tires with steel wires are placed into the bead-cutting machine to cut the target waste tires into beads and the first remaining portions separated from the beads. Then the first remaining portions are placed into the strip-cutting machine, to cut the first remaining portions into strips of the same widths for facilitating a sequence step. Then beads with steel wires is processed by the tire bead peeler. Then the waste tires after the processing are placed in the air-water-cooled system, the micro dust removal device and the atomization spraying system of the tire crusher, to soak the waste tire blocks to soften the waste tire blocks to change the characteristics of the waste tire blocks themselves. Then a crushing process is performed by adjusting a screen inside the tire crusher to be one thousand meshes. Then a series of processes including cleaning, crushing, magnetic separation, fiber separation, sieving, desulphurizing, and cooling are performed to obtain recycled resources of the waste tires. Ultra-fine rubber powders of one thousand meshes are finally obtained, thereby ensuring a quality of the ultra-fine rubber powders, while optimizing the process and improving a utilization rate of the recycled resource

### BRIEF DESCRIPTION OF DRAWINGS

FIG. 1 illustrates a schematic view of steps of a waste tire resourceful regeneration treatment method according to an embodiment of the present disclosure.

FIG. 2 illustrates a schematic flowchart of a cleaning process according to an embodiment of the present disclosure.

FIG. 3 illustrates a schematic flowchart of a sieving process according to an embodiment of the present disclosure.

### DETAILED DESCRIPTION OF EMBODIMENTS

Technical solutions of embodiments of the present disclosure will be clearly and completely described hereinafter in combination with accompanying drawings of the embodiments of the present disclosure. It is apparent that the embodiments described are merely part but not all of embodiments of the present disclosure. All other embodiments obtained by the skilled in the art based on the embodiments of the present disclosure without creative labors fall within the scope of protection of the present disclosure.

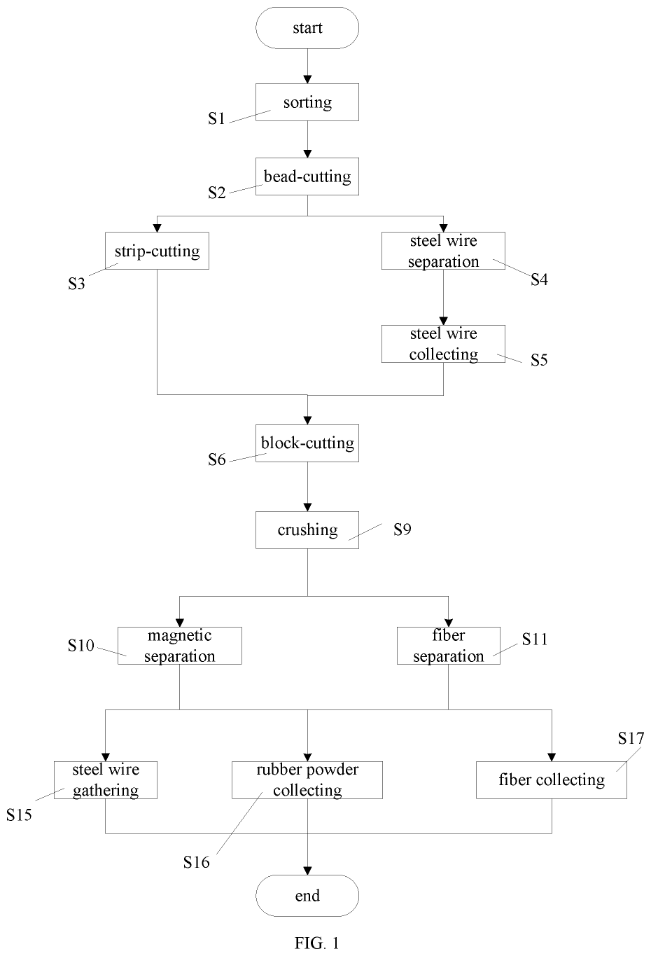

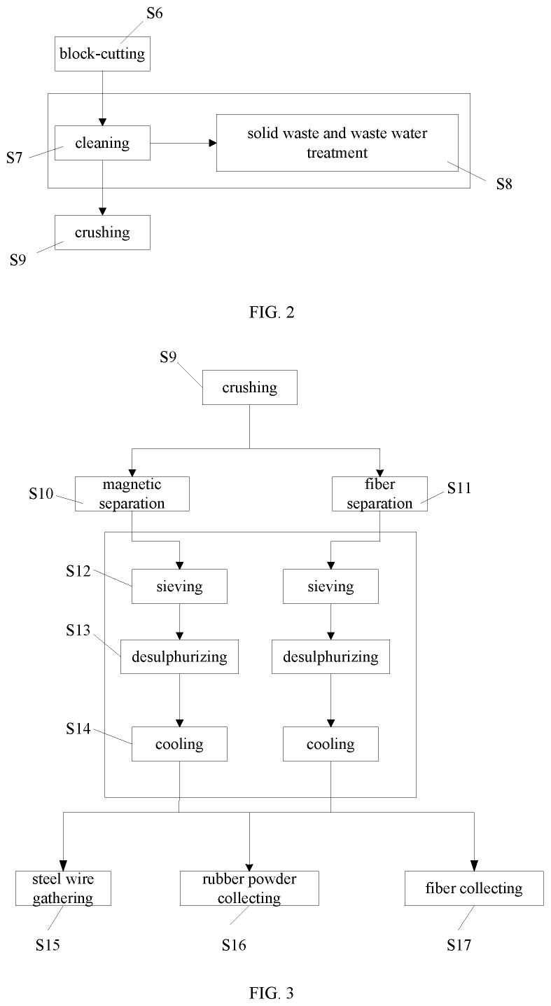

Referring to FIGS. 1 to 3, a waste tire resourceful regeneration treatment method is provided according to an embodiment of the present disclosure, and the method may include following steps:
step S1, sorting, including: sorting waste tires according to types of the waste tires to obtain target waste tires with steel wires;
step S2, bead-cutting, including: performing a bead-cutting process on the target waste tires through a bead-cutting machine, to cut the target waste tires into beads and first remaining portions separated from the beads for facilitating a sequence step;
step S3, strip-cutting, including: performing a strip-cutting process on the first remaining portions, through a strip-cutting machine, to cut the first remaining portions into strips for facilitating disassembly of the waste wires;
step S4, steel wire separation, including: performing a steel wire separation process on the beads obtained in the step S2 through a tire bead peeler, to obtain the steel wires and second remaining portions separated from the steel wires;
step S5, steel wire collecting, including: centralizedly collecting the steel wires obtained in the step S4;
step S6, block-cutting, including: performing a block-cutting process on the strips obtained in the step S3 and the second remaining portions obtained in the step S4, to obtain tire rubber blocks;
step S7, cleaning, including: repeatedly cleaning the tire rubber blocks to flush dust and impurities attached to surfaces of the tire rubber blocks;
step S8, solid waste and waste water treatment, including: centralizedly processing and discharging solid particle impurities and waste water generated after the cleaning;
step S9, crushing, including: placing the tire rubber blocks after the cleaning in the step S7 into a tire crusher to perform a crushing process on the tire rubber blocks and thereby process the tire rubber blocks into rubber powders, where a precision of the rubber powders is adjustable in the crushing process by controlling a mesh number of a screen of the tire crusher.
step S10, magnetic separation, including: placing the rubber powders obtained after the crushing into a magnetic separator to perform a magnetic separation process on the rubber powders, to remove ferromagnetic materials from the rubber powders through multiple times of magnetic separations, for improving a quality of the rubber powders;
step S11, fiber separation, including: placing the rubber powders obtained after the magnetic separation into a fiber separation machine, floating fibers (also referred to as fine lint fibers) of the rubber powders through an airflow produced by the fiber separation machine, and discharging the floated fibers through a conduit under an action of the airflow to obtain the fibers contained by the rubber powders;
step S12, sieving, including: performing a sieving process on the rubber powders obtained after the fiber separation;
step S13, desulphurizing, including: performing a desulphurizing process on the rubber powders obtained after the sieving through a vulcanizer, to heat up the rubber powders and thereby make rubber molecules of the rubber powders cross-linked to change a structure of the rubber powders from a linear structure into a reticulate body structure and obtain a rubber powder product with a certain physical and mechanical property, where in the desulphurizing process, the rubber powders are heated to be softened and water and volatile substances contained in the rubber powders tend to be gasified, a preset pressure is applied through a hydraulic cylinder to make the rubber powders fully fill a mold and suppress generation of gas bubbles and thereby make the rubber powder product have a dense organization structure and reduce pollution of environment due to waste gas;
step S14, cooling, including: performing a cooling process on the rubber powder product obtained after the desulphurizing;
step S15, steel wire gathering, including: gathering and centralizedly storing the steel wires;
step S16, rubber powder collecting, including: collecting and centralizedly storing the rubber powder product; and
step S17, fiber collecting, including: collecting and centralizedly storing the obtained fibers.

In an embodiment, referring to FIG. 1, in the step S2, the bead-cutting machine holds and fixes the target wastes wires through a four-jaw clamp of the bead-cutting machine and cuts the beads from the target waste wires in a side cutting manner.

In an embodiment, referring to FIG. 1, in the step S3, a cutting specification size of the strip-cutting machine is in a range from 35 millimeters (mm) to 45 mm, and the cutting specification size is adjustable.

In an embodiment, referring to FIG. 1, in the step S4, a power of a motor of the tire bead peeler is 15 kilowatts (kW), and the tire bead peeler is electrically connected to an industrial voltage of 380 volts (V), and the tire bead peeler processes the beads with steel wires to obtain the steel wires contained in the beads, for achieving reuse of resources.

In an embodiment, referring to FIG. 1, in the step S6, a cutting feeding specification size of the tire block-cutting machine is in a range from 35 mm to 40 mm, a feeding-out size of the tire block-cutting machine is in a range from 3 centimeters (cm) to 5 cm, and a cutting tool of the tire block-cutting machine is a carbide tool, and the carbide tool performs the block-cutting process on the waste wires, thereby ensuring a quality of cutting of the waste tires and increase the life of the cutting tool inside the tire block-cutting machine.

In an embodiment, referring to FIG. 1, in the step S7, a pressurized washing manner is used during the cleaning; and in the step S8, the generated waste water is processed by a water processing device to meet a discharge standard, thereby preventing toxic substances contained in the waste water from being discharged to the outside or in nature and causing damage to resources.

In an embodiment, referring to FIG. 1, in the step S9, the tire crusher is equipped with an air-water-cooled system, a micro dust removal device and an atomization spraying system; and the mesh number of the screen of the tire crusher is thousand meshes and thereby the tire crusher is capable of producing ultra-fine rubber powders, and the mesh number of the screen of the tire crushed is capable of being adjusted for facilitating the processing of the tire rubber blocks into the ultra-fine rubber powders.

In an embodiment, referring to FIG. 1, in the step S10, the magnetic separator removes 0.1 kilograms (kg) to 40 kg of the ferromagnetic material through once magnetic separation; in the step S11, the fiber separator drives an impeller through a main shaft at an output end of the motor to generate the airflow; and in each of the steps S1, S2, S3, S4, S5, S6, S7, S8, S9, S10 and S11, a gaseous sulfide detector is used to perform a real-time detection.

In an embodiment, referring to FIG. 1, the steps S12, S13 and S14 are each implemented in room; and a desulfurization steam temperature in the vulcanizer in the step S13 is controlled to be 540 Celsius degrees (° C.) for ensuring an effect of rubber powder desulfurization.

In an embodiment, referring to FIG. 1, the steps S15, S16 and S17 are all to collect regeneration resources generated from the target waste tires, thereby reducing waste of resources and make the waste tires be reused and avoid environmental damage.

The operating principle of the present disclosure is as follows. As shown in FIGS. 1 to 3, when the waste tire resourceful regeneration treatment method is applied, firstly, by sorting waste tires of different types, target waste tires with steel wires are obtained and placed together. Then, the target waste tires with steel wires are placed into a bead-cutting machine, the bead-cutting machine is started, and the beads with steel wires are removed from the target waste tires with steel wires by the tire bead cutting machine. Then the beads with steel wires are collected together. Then first remaining portions separated from the beads are placed into the strip-cutting machine, to cut the first remaining portions into strips of the same widths for facilitating a sequence step. Then beads is processed by a tire bead peeler, specifically, the beads is held by the tire bead peeler to remove the steel wires from the beads to obtain the steel wires and second remaining portions separated from the steel wires, and then the removed steel wires are collected centralizedly. Then, the waste wires without steel wires are placed into a tire block-cutting machine, a cutting feeding specification size of the tire block-cutting machine is adjusted to be in a range from 30 mm to 45 mm, the strips and the second remaining portions are placed into the tire block-cutting machine, and the tire block-cutting machine is started to obtain tire rubber blocks with a size in a range from 30 mm to 40 mm. Then, the cut tire rubber blocks are placed inside a cleaning tank to repeatedly clean the tire rubber blocks to flush dust and impurities attached to surfaces of the tire rubber blocks in a pressurized washing manner, and then the tire rubber blocks are vibrated by a vibrator inside the cleaning tank, the cleaning process is performed 3 to 6 times until the dust and impurities on the surface of the tire rubber block are substantially removed, and then the solid particle impurities and waste water generated after the cleaning are discharged through the cleaning tank. Then the generated waste water is processed by a water processing device to meet a qualified discharge standard. Then the tire rubber blocks after the cleaning are placed in an air-water-cooled system, a micro dust removal device and an atomization spraying system of a tire crusher, to soften the tire rubber blocks to change the characteristics of the tire rubber blocks, and then a crushing process is performed by adjusting a screen inside the tire crusher to be one thousand meshes. Then, the rubber powders obtained after the process of the tire crusher are collected and placed into a magnetic separator, the magnetic separator can remove 0.1 kilograms (kg) to 40 kg of a ferromagnetic material from the rubber powders through once magnetic separation, the ferromagnetic material in the rubber powders are repeatedly removed until the ferromagnetic material in the rubber powders is completely removed, thereby improve a quality of the rubber powders. Then, the rubber powders of which the ferromagnetic material is removed are placed into a fiber separation machine. A center of the fiber separation machine is provided with a transmission device, impellers is installed on a main shaft of the transmission device. The main shaft, a wind blade, and a wind blade plate are connected together with each other. With the rotation of the main shaft, the main shaft drives the impellers to rotate in a high-speed, to bring rubber powder particles and rubber powders with fine lint fibers into the fiber separation machine. The impellers on both sides of the fiber separation machine rotate rapidly to generate an airflow, under an action of the airflow, a wind pressure near the wind blade is lower than a wind pressure in the fiber separation machine, which causes of the fine lint fibers of the rubber powder particles or the rubber powders to rise and float, the fine lint fibers are discharged through a conduit under the action of the airflow, and the pure rubber powder particles and rubber powders cannot float due to a larger gravity thereof, thereby ensuring that the desired fibers are separated. Then, the rubber powders obtained after the fiber separation are sieved. Then, the rubber powders obtained after the sieving is placed into a vulcanizer, and a desulfurization steam temperature in the vulcanizer is controlled to be 540° C. for ensuring an effect of rubber powder desulfurization. Then, the rubber powders obtained after the desulphurizing are placed into a cooling chamber for cooling, and then recycled resources including the steel wires, the rubber powders and the fibers are obtained finally from the waste tires. Ultra-fine rubber powders of one thousand meshes are finally obtained, thereby ensuring a quality of the ultra-fine rubber powders, while optimizing the process and improving a utilization rate of the recycled resources, which are the characteristics of this waste tire resourceful regeneration treatment method.

Although embodiments of the present disclosure have been shown and described above, it will be understood to the skilled in the art that a variety of variations, modifications, and replacements of these embodiments can be made without departing from the principles and spirit of the present disclosure, the scope of which is limited by the appended claims and equivalents thereof.

What is claimed is:

1. A waste tire resourceful regeneration treatment method, comprising:
step S1, sorting, comprising: sorting waste tires according to types of the waste tires to obtain target waste tires with steel wires;
step S2, bead-cutting, comprising: performing a bead-cutting process on the target waste tires through a bead-cutting machine, to cut the target waste tires into beads and first remaining portions separated from the beads;
step S3, strip-cutting, comprising: performing a strip-cutting process on the first remaining portions, through a strip-cutting machine, to cut the first remaining portions into strips;
step S4, steel wire separation, comprising: performing a steel wire separation process on the beads obtained in the step S2 through a tire bead peeler, to obtain the steel wires and second remaining portions separated from the steel wires;
step S5, steel wire collecting, comprising: centralizedly collecting the steel wires obtained in the step S4;
step S6, block-cutting, comprising: performing a block-cutting process on the strips obtained in the step S3 and the second remaining portions obtained in the step S4, to obtain tire rubber blocks;
step S7, cleaning, comprising: repeatedly cleaning the tire rubber blocks to flush dust and impurities attached to surfaces of the tire rubber blocks;
step S8, solid waste and waste water treatment, comprising: centralizedly processing and discharging solid particle impurities and waste water generated after the cleaning;
step S9, crushing, comprising: placing the tire rubber blocks after the cleaning in the step S7 into a tire crusher to perform a crushing process on the tire rubber blocks and thereby process the tire rubber blocks into rubber powders, wherein a precision of the rubber powders is adjustable in the crushing process by controlling a mesh number of a screen of the tire crusher.
step S10, magnetic separation, comprising: placing the rubber powders obtained after the crushing into a magnetic separator to perform a magnetic separation process on the rubber powders, to remove ferromagnetic materials from the rubber powders through multiple times of magnetic separations;
step S11, fiber separation, comprising: placing the rubber powders obtained after the magnetic separation into a fiber separation machine, floating fibers of the rubber powders through an airflow produced by the fiber separation machine, and discharging the floated fibers through a conduit under an action of the airflow to obtain the fibers contained by the rubber powders;
step S12, sieving, comprising: performing a sieving process on the rubber powders obtained after the fiber separation;
step S13, desulphurizing, comprising: performing a desulphurizing process on the rubber powders obtained after the sieving through a vulcanizer, to heat up the rubber powders and thereby make rubber molecules of the rubber powders cross-linked to change a structure of the rubber powders from a linear structure into a reticulate body structure and obtain a rubber powder product with a certain physical and mechanical property, wherein in the desulphurizing process, the rubber powders are heated to be softened and water and volatile substances contained in the rubber powders tend to be gasified, a preset pressure is applied through a hydraulic cylinder to make the rubber powders fully fill a mold and suppress generation of gas bubbles and thereby make the rubber powder product have a dense organization structure and reduce pollution of environment due to waste gas;
step S14, cooling, comprising: performing a cooling process on the rubber powder product obtained after the desulphurizing;
step S15, steel wire gathering, comprising: gathering and centralizedly storing the steel wires;
step S16, rubber powder collecting, comprising: collecting and centralizedly storing the rubber powder product; and
step S17, fiber collecting, comprising: collecting and centralizedly storing the obtained fibers.

2. The waste tire resourceful regeneration treatment method according to claim 1, wherein in the step S2, the bead-cutting machine holds and fixes the target wastes wires through a four-jaw clamp of the bead-cutting machine and cuts the beads from the target waste wires in a side cutting manner.

3. The waste tire resourceful regeneration treatment method according to claim 1, wherein in the step S3, a cutting specification size of the strip-cutting machine is in a range from 35 millimeters (mm) to 45 mm, and the cutting specification size is adjustable.

4. The waste tire resourceful regeneration treatment method according to claim 1, wherein in the step S4, a power of a motor of the tire bead peeler is 15 kilowatts (kW), and the tire bead peeler is electrically connected to an industrial voltage of 380 volts (V).

5. The waste tire resourceful regeneration treatment method according to claim 1, wherein in the step S6, a cutting feeding specification size of the tire block-cutting machine is in a range from mm to 40 mm, a feeding-out size of the tire block-cutting machine is in a range from 3 centimeters (cm) to 5 cm, and a cutting tool of the tire block-cutting machine is a carbide tool.

6. The waste tire resourceful regeneration treatment method according to claim 1, wherein in the step S7, a pressurized washing manner is used during the cleaning; and in the step S8, the generated waste water is processed by a water processing device to meet a discharge standard.

7. The waste tire resourceful regeneration treatment method according to claim 1, wherein in the step S9, the tire crusher is equipped with an air-water-cooled system, a micro dust removal device and an atomization spraying system; and the mesh number of the screen of the tire crusher is thousand meshes and thereby the tire crusher is capable of producing ultra-fine rubber powders.

8. The waste tire resourceful regeneration treatment method according to claim 1, wherein in the step S10, the magnetic separator removes 0.1 kilograms (kg) to 40 kg of the ferromagnetic material through once magnetic separation; in the step S11, the fiber separator drives an impeller through a main shaft at an output end of the motor to generate the airflow; and in each of the steps S1, S2, S3, S4, S5, S6, S7, S8, S9, S10 and S11, a gaseous sulfide detector is used to perform a real-time detection.

9. The waste tire resourceful regeneration treatment method according to claim 1, wherein the steps S12, S13 and S14 are each implemented in room; and a desulfurization steam temperature in the vulcanizer in the step S13 is controlled to be 540 Celsius degrees (° C.).

10. The waste tire resourceful regeneration treatment method according to claim 1, wherein the steps S15, S16 and S17 are all to collect regeneration resources generated from the target waste tires.
